(19) United States
(12) Patent Application Publication
(10) Pub. No.: US 2016/0268667 A1
(43) Pub. Date: Sep. 15, 2016

(54) Dielectric Waveguide Input/Output Structure and Dielectric Waveguide Filter Using The Same

(71) Applicant: TOKO, INC., Tsurugashima-shi (JP)

(72) Inventor: Yukikazu YATABE, Tsurugashima-shi (JP)

(21) Appl. No.: 15/048,572

(22) Filed: Feb. 19, 2016

(30) Foreign Application Priority Data
Mar. 13, 2015 (JP) 2015-050463

(51) Int. Cl. H01P 3/16; H01P 1/20

(52) U.S. Cl. CPC H01P 3/16; H01P 1/2002

(57) ABSTRACT

[Technical problem]

A conventional dielectric waveguide input/output structure has a strength of coupling which is adjusted by a length of an input/output electrode. However, there is a limitation in an adjustable range of the coupling, which makes it impossible to have an input/output structure with wider bandwidth.

[Solution to the technical problem]

A dielectric waveguide input/output structure is provided, which comprises an input/output point provided near the center on one side of a bottom surface of a rectangular parallelepiped-shaped dielectric body, wherein an outer periphery of the dielectric body is covered with an electrically conductive film, except for an L-shaped lateral part extending along an edge of the bottom surface from opposite sides of the input/output point and for a surrounding part of the input/output point in a lateral surface with which the input/output point is in contact.

### CROSS-REFERENCE TO RELATED APPLICATION

Basic application: Japanese Patent Application No. 2015-050463 filed on Mar. 13, 2015.

### BACKGROUND OF THE INVENTION

1. Field of the Invention

The present invention relates to an input/output structure of a dielectric waveguide, and, in particular, to an input/output structure suitable for mounting on a printed circuit board, and the like.

2. Description of the Related Art

There has been used a dielectric waveguide input/output structure comprising an input/output electrode formed on a bottom surface and lateral walls of a dielectric waveguide resonator which performs input and output, as an input/output structure for directly mounting, on a printed circuit board, a dielectric waveguide filter, a dielectric waveguide duplexer, or the like comprising a plurality of dielectric waveguide resonators coupled to each other.

FIG. 8 is a lower perspective view illustrating an example of a dielectric waveguide filter comprising a conventional dielectric waveguide input/output structure described in JP 2002-135003A. A dielectric waveguide filter 100 comprises dielectric waveguide resonators 102, 102 having a rectangular parallelepiped shape as an outer shape and TE mode as a resonant mode. The dielectric waveguide resonators 102, 102 are coupled to each other via a slit 103. In a bottom surface 102b of each of the dielectric waveguide resonators 102, 102, there is provided a band-like input/output electrode 105 that extends from the center on one side of the bottom surface 102b to a direction of opposing sides. Each dielectric waveguide resonator 102 is covered with an electrically conductive film, except for opposite sides 106, 106 of the input/output electrode 105 and for a lateral opening 107 surrounding the input/output electrode 105 in a lateral surface 102a with which the input/output electrode 105 is in contact.

### BRIEF SUMMARY OF THE INVENTION

### Problem to be Solved by the Invention

The dielectric waveguide input/output structure as described above has a strength of coupling which is adjusted by a length of the input/output electrode. However, there is a limitation in an adjustable range of the coupling, which makes it impossible to have an input/output structure with wider bandwidth.

### Means for Solving the Problem

A dielectric waveguide input/output structure of the present invention comprises an input/output point provided near the center on one side of a bottom surface of a rectangular parallelepiped-shaped dielectric body, wherein an outer periphery of the dielectric body is covered with an electrically conductive film, except for an L-shaped lateral part extending along an edge of the bottom surface from opposite sides of the input/output point and for a surrounding part of the input/output point in a lateral surface with which the input/output point is in contact.

### Effect of the Invention

According to the present invention, it becomes possible to provide an input/output structure with wider bandwidth, having wider adjustable range of coupling.

### BRIEF DESCRIPTION OF THE DRAWINGS

FIG. 1A illustrates an embodiment of a dielectric waveguide filter comprising a dielectric waveguide input/output structure of the present invention.

FIG. 1B illustrates an example of mounting the dielectric waveguide filter in FIG. 1A on a substrate.

FIG. 2 illustrates a simulation result of an external Q of a conventional dielectric waveguide input/output structure.

FIG. 3 illustrates a simulation result of an external Q of the dielectric waveguide input/output structure of the present invention.

FIG. 4A is a diagram for explaining a horizontal axis of FIG. 2.

FIG. 4B is a diagram for explaining a horizontal axis of FIG. 3.

FIG. 5 illustrates a result of simulating a magnetic-field strength distribution inside a resonator.

FIG. 6A schematically illustrates the conventional dielectric waveguide input/output structure.

FIG. 6B schematically illustrates the dielectric waveguide input/output structure of the present invention.

FIG. 7 illustrates an alternative embodiment of the dielectric waveguide input/output structure of the present invention.

FIG. 8 illustrates an example of the conventional dielectric waveguide input/output structure.

### DETAILED DESCRIPTION OF THE INVENTION

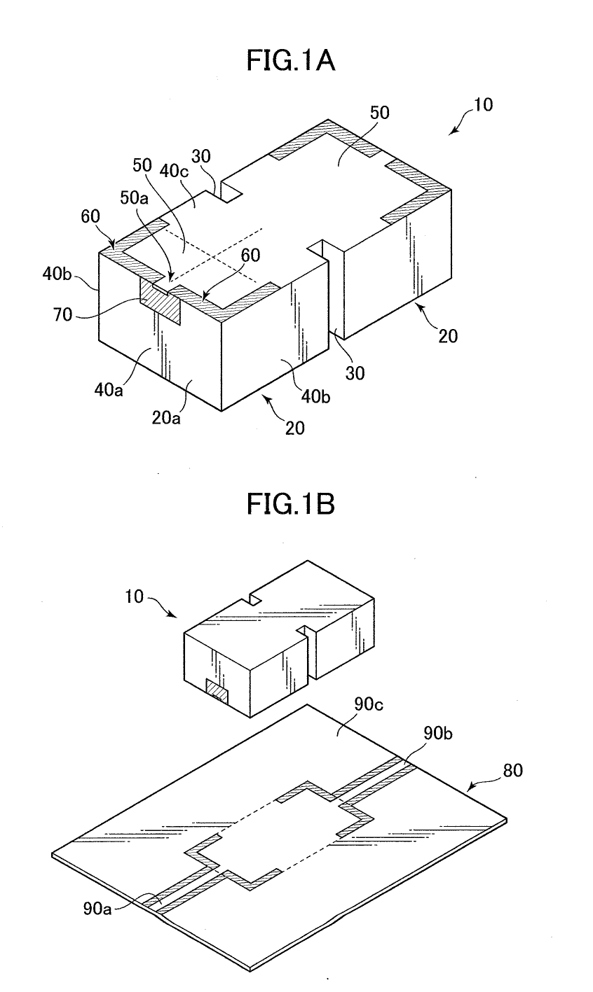

FIG. 1A illustrates a perspective view for explaining an embodiment of a dielectric waveguide filter comprising a dielectric waveguide input/output structure of the present invention, with a bottom surface up.

FIG. 1B illustrates a perspective view for explaining mounting of the dielectric waveguide filter illustrated in FIG. 1A on a substrate.

As illustrated in FIG. 1A, a dielectric waveguide filter 10 comprises dielectric waveguide resonators 20, 20, each consisting of a rectangular parallelepiped-shaped dielectric body, and having TE mode as a resonant mode. The dielectric waveguide resonators 20, 20 are coupled to each other via a slit 30.

Each of the dielectric waveguide resonators 20, 20 comprises a rectangular input/output electrode 50 defining an input/output point 50a near the central region on one side of a bottom surface 40c, and is covered with an electrically conductive film 20a, except for an L-shaped lateral parts 60, 60 extending along an edge of the bottom surface 40c from opposite sides of the input/output point 50a, and for a lateral opening 70 surrounding the input/output point 50a in a lateral surface 40a of the dielectric waveguide resonator with which the input/output point 50a is in contact.

As illustrated in FIG. 1B, the dielectric waveguide filter 10 is mounted on a printed circuit board 80 which comprises lines 90a, 90b each having a distal end formed in an approximately the same shape as the input/output electrode 50, and a ground pattern 90c. In this case, the distal end of each of the lines 90a, 90b is connected to respective one of the input/output electrodes 50, 50, and the electrically conductive film 20a is connected to the ground pattern 90c. The lines 90a, 90b are, for example, microstrip lines or coplanar lines.

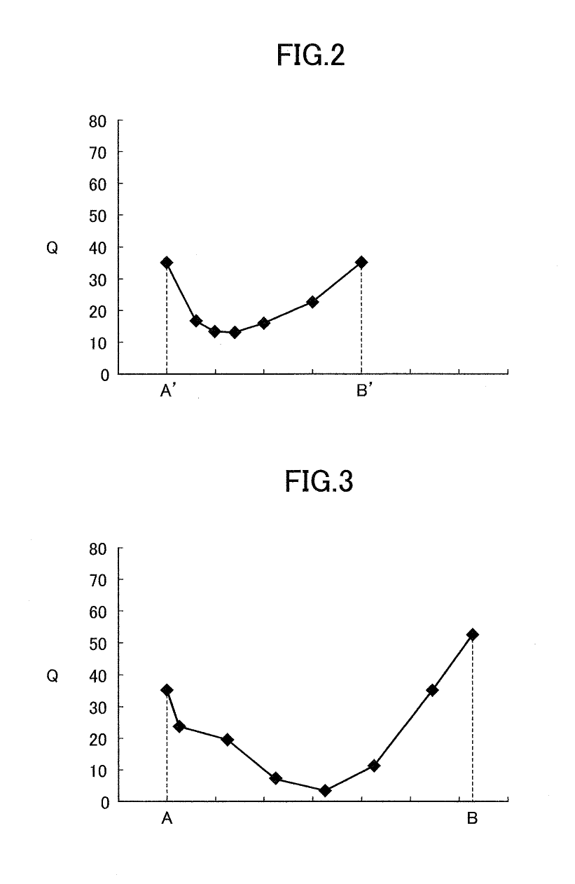

FIG. 2 illustrates a graph of a result of simulating a dielectric waveguide filter comprising a conventional dielectric waveguide input/output structure.

FIG. 3 illustrates a graph of a result of simulating a dielectric waveguide filter comprising the dielectric waveguide input/output structure of the present invention.

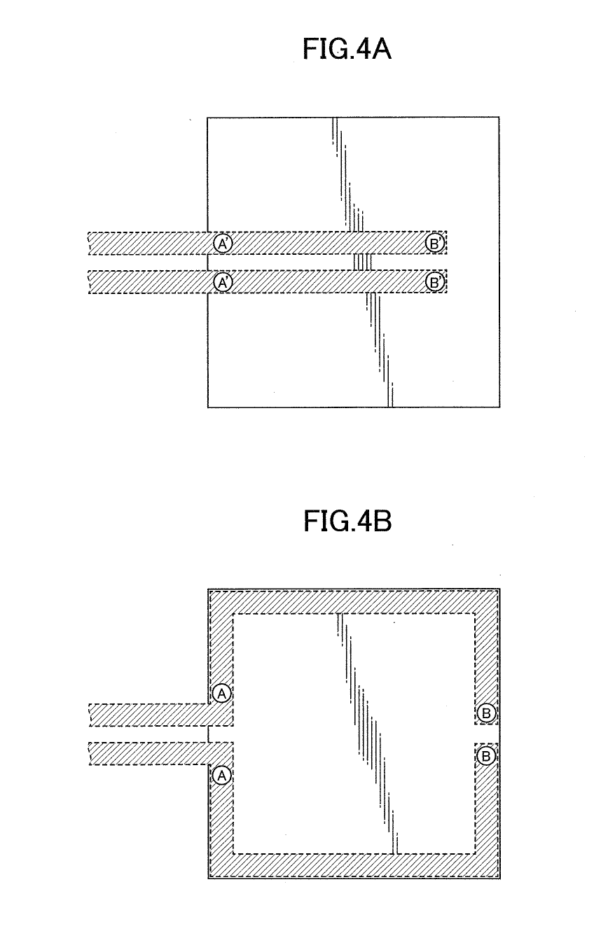

In FIG. 2, the horizontal axis represents a relative length between lateral parts A′ and B′ in the illustration of FIG. 4A, and the vertical axis represents an external Q.

In FIG. 3, the horizontal axis represents a relative length between lateral parts A and B in the illustration of FIG. 4B, and the vertical axis represents an external Q. It is noted that the external Q is a reciprocal of coupling.

It can be seen from the results of FIGS. 2 and 3 that the dielectric waveguide input/output structure of the present invention has a lower minimum value of external Q as compared to the conventional dielectric waveguide input/output structure, and that the external Q becomes minimum when a distal end of edge is near the central portion of adjacent side.

This is considered to occur for the following reason.

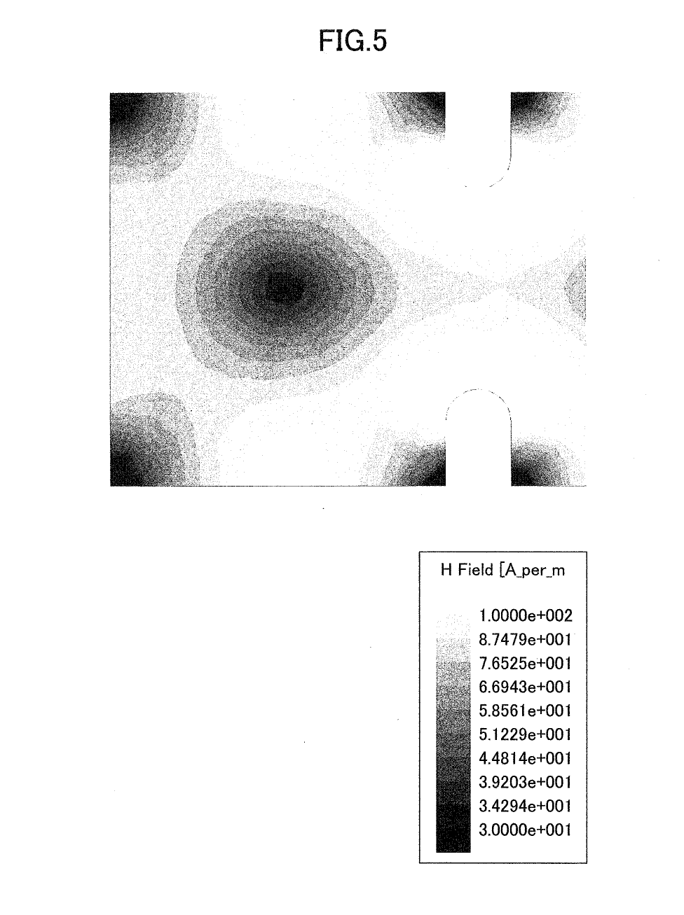

FIG. 5 illustrates a result of simulating a magnetic-field strength distribution inside a resonator. As illustrated in the simulation of FIG. 5, the magnetic field is strongest in lateral sides near the center of the resonator, and weakest in the center and corners of the resonator.

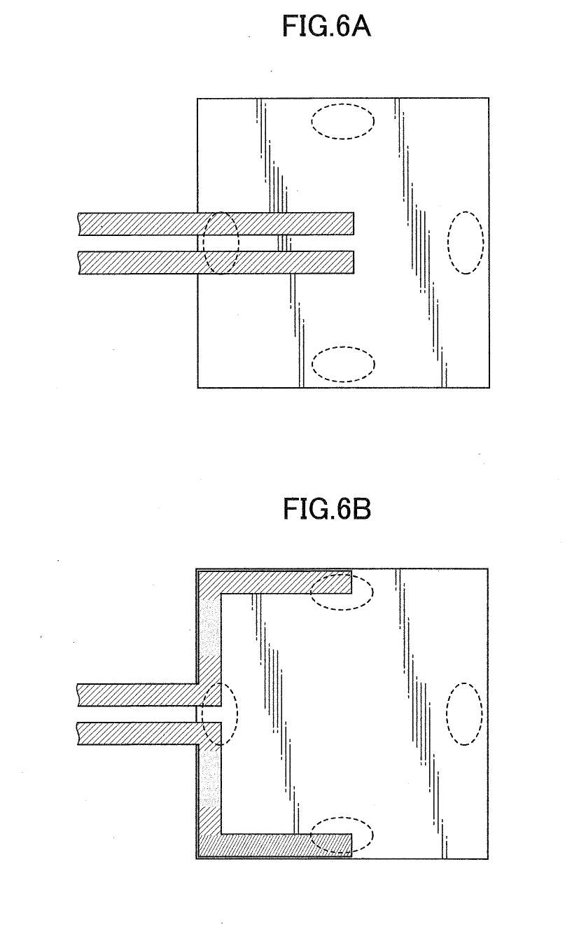

FIG. 6A schematically illustrates the conventional dielectric waveguide input/output structure, and FIG. 6B schematically illustrates the dielectric waveguide input/output structure of the present invention. In FIGS. 6A and 6B, dashed lines indicate locations with the largest magnetic field in the result of FIG. 5.

The conventional dielectric waveguide input/output structure illustrated in FIG. 6A intersects with the lateral part at only one location of the locations with largest magnetic field in the dielectric resonator, whereas the dielectric waveguide input/output structure of the present invention illustrated in FIG. 6B intersects with the lateral part at three locations of the locations with largest magnetic field in the dielectric resonator.

For this reason, it is possible for the latter to have a smaller external Q.

Since the dielectric waveguide input/output structure of the present invention enables the adjustable range of coupling to be wider than the conventional dielectric waveguide input/output structure in this way, it becomes possible to have an input/output structure with wider bandwidth.

It is noted that when the dielectric waveguide is mounted on a substrate, the electromagnetic field is likely to leak from a small gap between a lateral surface and a bottom surface of the dielectric waveguide, making the coupling strength reduced. A fillet formed by a solder between the substrate and the lateral surface of the dielectric waveguide can easily prevent the leakage of the electromagnetic field.

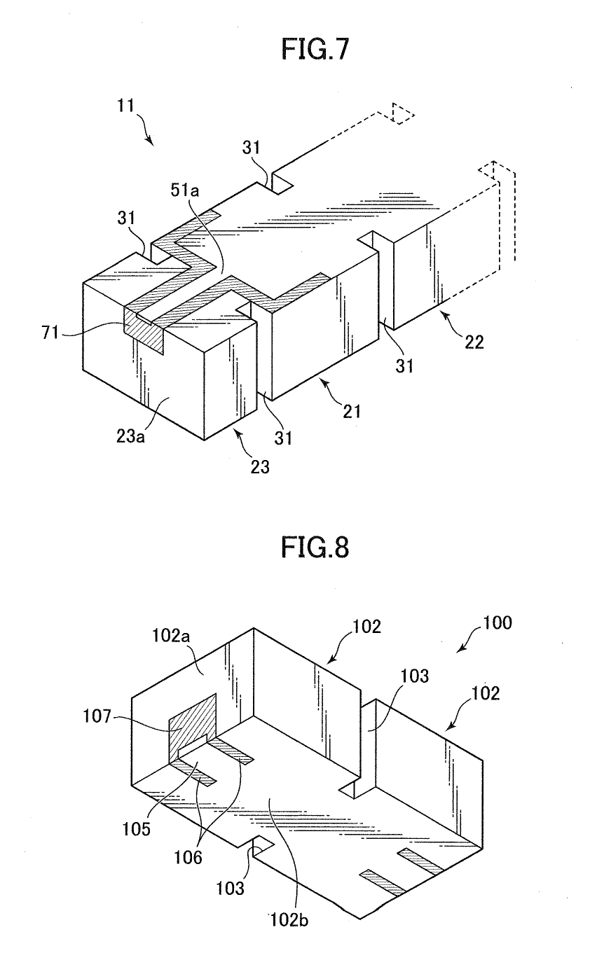

FIG. 7 is a perspective view illustrating an alternative embodiment of a dielectric waveguide filter comprising the dielectric waveguide input/output structure of the present invention, with a bottom surface up.

As illustrated in FIG. 7, a dielectric waveguide filter 11 comprises rectangular parallelepiped-shaped dielectric waveguide resonators 21, 22 and a rectangular parallelepiped-shaped dielectric block 23 that is smaller than the dielectric waveguide resonators 21, 22, which are serially connected via a slit 31.

An input/output point 51a provided on one side of a bottom surface of the dielectric waveguide resonator 21 is extended across the bottom surface to an end surface 23a of the adjacently-disposed dielectric block 23.

By having such a structure, the leakage of the electromagnetic field at the input/output point can be prevented.

It is noted that the dielectric waveguide input/output structure is not necessarily required to be provided in the resonators positioned at either end of the dielectric waveguide filter.

If other dielectric waveguide resonators are located on opposite sides of a dielectric waveguide resonator, it may have an input/output point provided on one side of the bottom surface thereof that is not adjacent to the other dielectric waveguide resonators.

### EXPLANATION OF CODES

10, 11, 12, 13, 100: dielectric waveguide filter
20, 21, 22a to 22f, 23a to 23f, 102: dielectric waveguide resonator
30, 31, 103: slit
40a, 40b, 41a, 41b, 102a: lateral surface
40c, 102b: bottom surface
50, 51, 105: input/output electrode
50a, 51a: input/output point
60, 61, 106: lateral part
70, 71, 107: lateral opening
80, 81, 82, 83: printed circuit board
90a, 90b, 91a, 91b, 92a, 92b, 93a, 93: line
90c: ground pattern

1. A dielectric waveguide input/output structure comprising an input/output point provided near the center on one side of a bottom surface of a rectangular parallelepiped-shaped dielectric body, wherein an outer periphery of the dielectric body constituting a dielectric waveguide resonator is covered with an electrically conductive film, except for an L-shaped lateral part extending along an edge of the bottom surface from opposite sides of the input/output point, and for a surrounding part of the input/output point in a lateral surface with which the input/output point is in contact.

2. The dielectric waveguide input/output structure as defined in claim 1, wherein the input/output point is connected to a line provided on a substrate, and an exterior of the dielectric body is connected to a ground pattern provided on the substrate.

3. The dielectric waveguide input/output structure as defined in claim 2, wherein a fillet is formed between a lateral surface of the dielectric body and the ground pattern.

4. The dielectric waveguide input/output structure as defined in claim 1, wherein a dielectric block that is smaller than the dielectric waveguide resonator is disposed adjacent to the dielectric waveguide resonator, and the input/output point extends across a bottom surface of the dielectric block to an end surface of the dielectric block.

5. A dielectric waveguide filter comprising the dielectric waveguide input/output structure as defined in claim 1.
